(19) United States
(12) Patent Application Publication
(10) Pub. No.: US 2003/0223598 A1
(43) Pub. Date: Dec. 4, 2003

(54) Sound picking device for microphones

(76) Inventor: Keng Kuei Su, Kaohsiung (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/155,081

(22) Filed: May 28, 2002

(51) Int. Cl. H04R 3/00

(52) U.S. Cl. 381/111; 381/113; 381/122

(57) ABSTRACT

A microphone includes a head and a shank and a separation board is located between the head and the shank so as to define two chambers. The first chamber has a first transferring member and the second chamber has a second transferring chamber. The two transferring members each have a sound picking device. The two transferring members generate a signal simultaneously when the microphone is hit and the two respective signals are opposite to each other so as to be eliminated. Therefore, the microphone does not generate huge noise.

### FIELD OF THE INVENTION

The present invention relates to a sound picking device including two transferring devices which generate two opposite signals for an income noise and the two opposite signals are eliminated so that no noise is generated.

### BACKGROUND OF THE INVENTION

A conventional microphone 1 is shown in FIG. 1 and generally includes head 12 and a shank 11. The head 12 includes a casing 121 with a plurality of apertures 122 defined therethrough and a sound picking device 124 is received in an interior 123 of the casing 121. An amplifier 111 is received in the shank 11 and a switch 13 is connected to the shank 11. An emitting member 2 is connected to the bottom of the shank 11 so as to send a signal therefrom which is then transferred into a sound by a proper machine. However, an inherent problem for the conventional microphone is that when the microphone is hit unintentionally, a huge noise generates. This is because the impact to the microphone is picked by the sound picking device 124 and is amplified by the amplifier 111. Although some manufacturers mount a spring or a rubber pad connected to the sound picking device to reduce the vibration to reduce noise, it is not satisfied by the users.

### SUMMARY OF THE INVENTION

In accordance with one aspect of the present invention, there is provided a microphone that has two transferring members respectively located in two chambers of the microphone. Each transferring member has a positive output terminal and a negative output terminal. The two positive output terminals are connected to each other and the two negative output terminals are connected to each other. The sound caused by touching the microphone activates the two transferring members which generate two reverse signals which are eliminated eventually.

The primary object of the present invention is to provide a microphone generates no noise when the microphone is touched or scraped.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 shows a conventional microphone which shows a sound picking device;

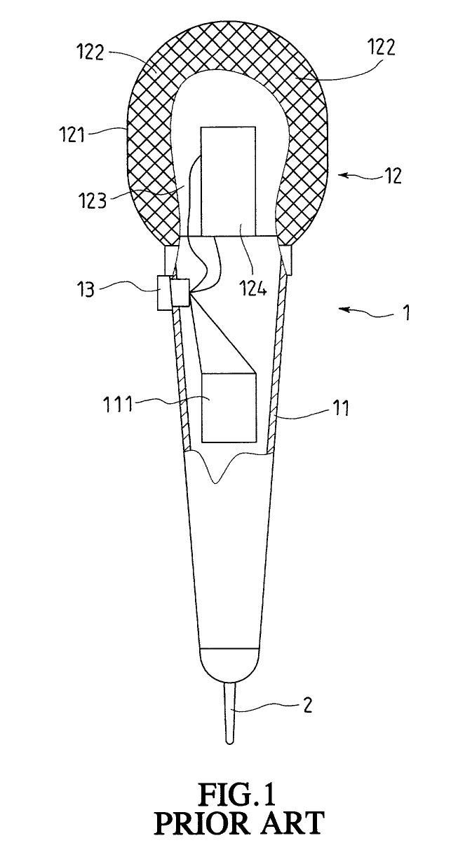

FIG. 2 is a cross sectional view to show the microphone of the present invention;

FIG. 3 shows the circuit of the transferring members, the sound picking devices and the output terminals of the microphone of the present invention, and

FIG. 4 shows an amplifier received in the microphone of the present invention.

### DETAILED DESCRIPTION OF THE PREFERRED EMBODIMENT

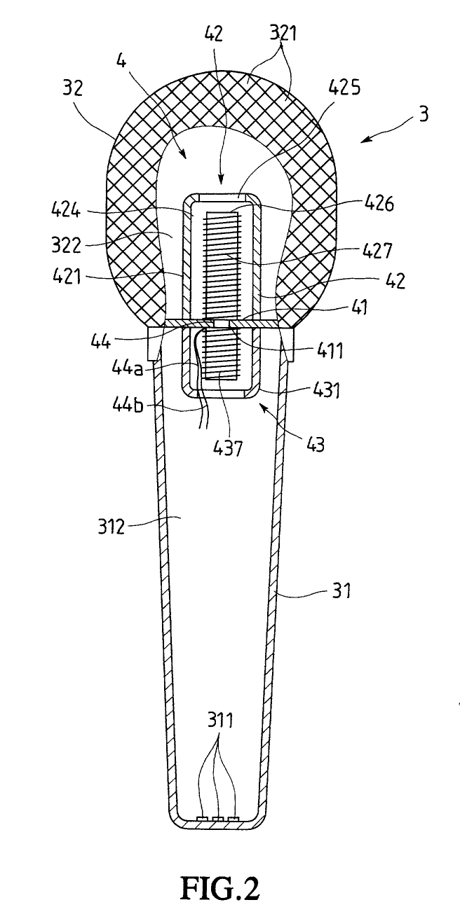

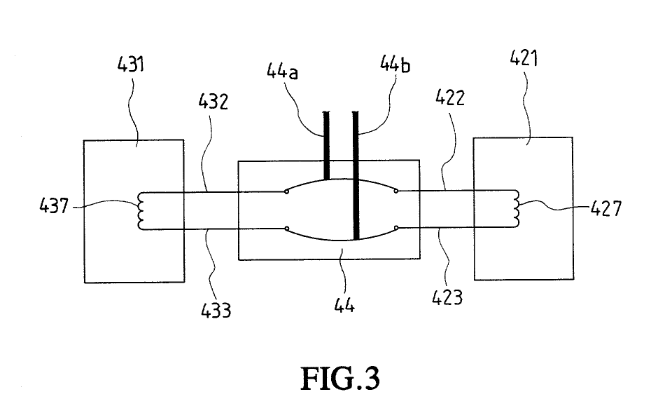

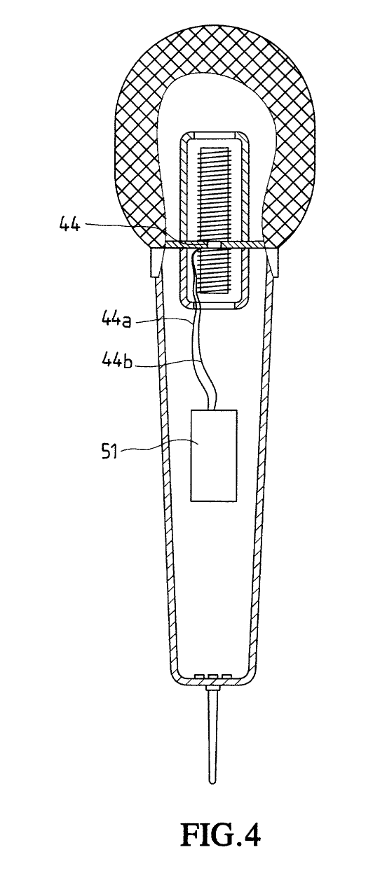

Referring to FIGS. 2 to 4, the microphone of the present invention comprises a head 3 and a shank 31. A plurality of output terminals 311 are connected to a bottom of the shank 31. A separation board 41 is connected between the head 3 and the shank 31 so as to define a first chamber 322 in the head 3 and a second chamber 312 in the shank 31.

A casing 32 having a plurality of apertures 321 is connected to the head 3 and encloses the first chamber 322 so that sound may enter in the first chamber 322 via the apertures 321. A circuit board 44 is engaged with a hole 411 defined through the separation board 41.

A first transferring member 42 is received in the first chamber 322 and has a first sound picking device 421 which is connected to a first positive output terminal 422 and a first negative input terminal 423 on the circuit board 44. The first sound picking device 421 is a coil type sound picking device and includes a casing 424 and a vibration film 425 which is connected to a top of the casing 424. A magnet 426 is received in the casing 424 and located beneath the vibration film 425. A coil 427 is mounted to the magnet 426 and connected to the first positive output terminal 422 and the first negative output terminal 423 so as to transfer a sound into a signal.

A second transferring member 43 is received in the second chamber 312 and has a second sound picking device 431 which is connected to a second positive output terminal 432 and a second negative input terminal 433 on the circuit board 44. The second picking device 431 has the same structure as the first sound picking device 421.

The first positive output terminal 422 is connected to the second positive output terminal 432, and the first negative input terminal 423 is connected to the second negative input terminal 433. The two connections form a first output unit 44a and a second output unit 44b which is connected to the earth. The circuit is then connected to an amplifier which can be located at the microphone or outside of the microphone.

The first sound picking device 421 and the second sound picking device 431 are activated by the same sound and transfer the sound into the same signal. The circuit board 44 seals the hole 411 of the separation board 41 so that a sound coming from outside of the microphone can only enter the first chamber 322. Only a sound that is caused by hitting the microphone can enter both the first chamber 322 and the second chamber 312.

When a noise caused by hitting or scraping the shank 31 or the casing 32 of the microphone, the sound activates the vibration film 425 on the casing 424 of the first sound picking device 421 and the vibration film on the casing of the second sound picking device 431. The two coils 427 and 437 are activated to generate a current which is transferred into a signal by the two transferring members 42, 43 simultaneously. The two respective position output terminals 422, 432 both output the same signals to the first output unit 44a so that the two signals are eliminated to each other so as to avoid a noise from being generated.

When a sound coming from outside of the microphone, only the first sound picking device 421 is activated and a signal is sent to the first output unit 44a and amplified via the output terminals 311.

By this arrangement, the microphone will not generate any noise caused by scraping or hitting the microphone. FIG. 5 shows that the amplifier 51 can be received in the shank 31 of a cordless microphone.

While we have shown and described the embodiment in accordance with the present invention, it should be clear to those skilled in the art that further embodiments may be made without departing from the scope of the present invention.

What is claimed is:

1. A microphone comprising:
a head and a shank, a separation board connected therebetween so as to define a first chamber and a second chamber in the head;
a first transferring member received in the first chamber and having a first sound picking device which is adapted to receive a sound entering the first chamber and send a signal, a first positive output terminal and a first negative input terminal respectively connected to the first picking device, and
a second transferring member received in the second chamber and having a second sound picking device which is adapted to receive a sound entering the second chamber and send a signal, a second positive output terminal and a second negative input terminal respectively connected to the second sound picking device, the first positive output terminal connected to the second positive output terminal, the first negative input terminal connected to the second negative input terminal.

2. The microphone as claimed in claim 1, wherein first negative output terminal and the second negative output terminal are connected to earth.

3. The microphone as claimed in claim 1 further comprising an amplifier connected to the first transferring member and the second transferring member.
